(19) United States
(12) Patent Application Publication
(10) Pub. No.: US 2023/0153776 A1
(43) Pub. Date: May 18, 2023

(54) LOCATION BASED DIGITAL GIFT REWARDS

(71) Applicant: Capital One Services, LLC, McLean, VA (US)

(72) Inventors: Timur Sherif, Silver Spring, MD (US); Michael Mossoba, Great Falls, VA (US); Asher Smith-Rose, Arlington, VA (US); Zviad Aznaurashvili, Reston, VA (US)

(21) Appl. No.: 17/530,164

(22) Filed: Nov. 18, 2021

(51) Int. Cl. G06Q 20/12; G06Q 20/38; G06T 19/00

(52) U.S. Cl. CPC G06Q 20/1235; G06Q 20/389; G06T 19/006; G06Q 2220/00

(57) ABSTRACT

A gifter initiates a digital gift reward for a giftee at a location. The digital gift reward is generated and associated with the location. The giftee is notified either when the digital gift reward is generated and/or when the giftee is near the location of the digital gift reward. The giftee receives instructions for claiming the digital gift reward, the instructions include conditions for transferring the digital gift reward to the giftee. The giftee can receive directions for navigating to the digital gift reward. The directions can be augmented reality based directions. When the conditions are satisfied, the digital gift reward can be transferred from the gifter's account to the giftee's account. The gifter may earn a gifting reward upon transfer of the digital gift reward. The gifting reward can be transferred to the gifter's account. The accounts are updated to reflect all transfers.

### BACKGROUND

Traditional gifting usually involves a physical transfer of tangible items/media between people. Gifting is most often accomplished physically person to person. However, it is difficult to leave a gift for someone in a public place and ensure that the giftee receives the gift. Further, gifts oftentimes include direct transfers of money from one account to another without any intrigue or effort for the giftee.

Geocaching has typically involved the use of global positioning satellite (GPS) coordinates for navigation to an intended target or “cache.” Once reaching the coordinates, the users typically find a physical item (e.g., gift, log) or must contact the generator over conventional means to receive a gift or an accolade. However, this process is more of a scavenger hunt and is not an automated, seamless, or private mechanism for transferring gifts between users.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In accordance with aspects of the innovation, a gifter initiates a digital gift or reward for a giftee at a location. The digital gift reward is generated and associated with the location. The giftee is notified either when the digital gift reward is generated and/or when the giftee is near (or approaching) the location of the digital gift reward. The giftee receives instructions for claiming the digital gift reward, the instructions include conditions for transferring the digital gift reward to the giftee. The giftee can receive directions for navigating to the digital gift reward. In specific embodiments, the directions can be augmented reality-based directions. When the conditions are satisfied, the digital gift reward can be transferred from the gifter's account to the giftee's account. The gifter may earn a gifting reward upon transfer of the digital gift reward. The gifting reward can be transferred to the gifter's account. The accounts can be updated to reflect all transfers.

In aspects, the subject innovation provides substantial benefits in terms of gifting, especially digital gifting. One advantage of the innovation resides in a seamless transfer of a digital gift reward upon a claim of the digital gift reward. Another advantage resides in secure digital geocaching-like treasure hunt of gifts that can be instantly redeemed in an online system.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a high level diagram of the subject innovation in accordance with aspects.

FIG. 2 illustrates an example component diagram of a gift management system of the subject innovation.

FIG. 3 illustrates an example component diagram of an interface component.

FIG. 4 illustrates an example component diagram of a transfer component.

FIG. 5 illustrates an example method for digital gift rewards from initiation to redemption in accordance with aspects of the innovation.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

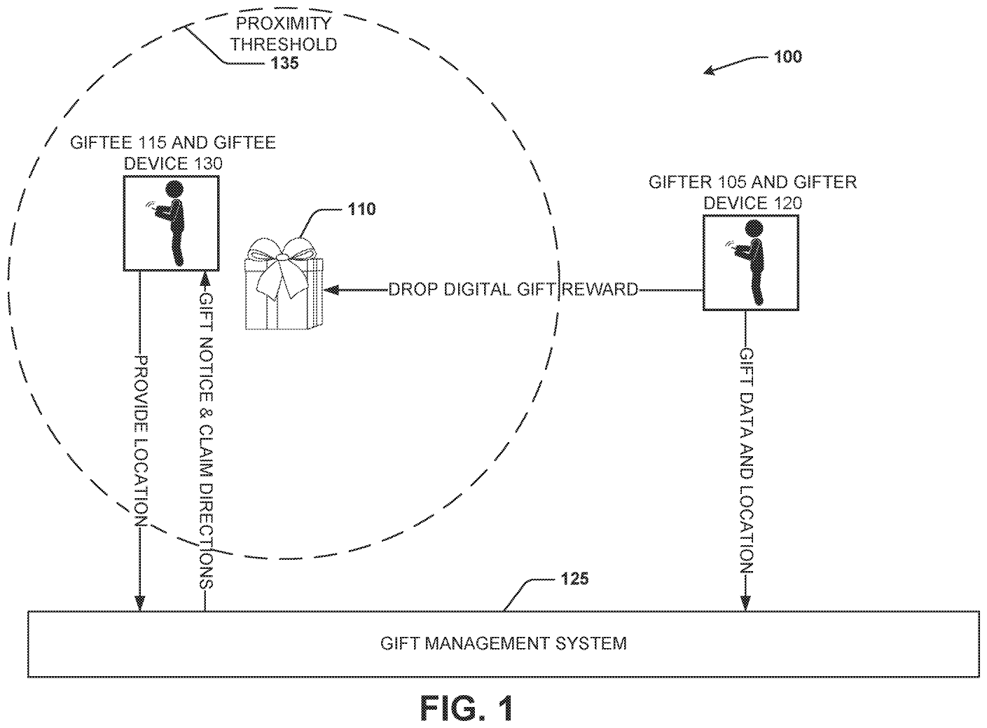

In accordance with the innovation, FIG. 1 illustrates a high level view of digital gift rewards. In operation, a user can initiate and prompt location-based gifts and/or rewards through a mobile app (e.g., a banking platform app). These gifts/rewards could either be monetary or digital (e.g. badges). In addition, the rewards could either be funded through a credit/debit card transaction, bank account, or credit card rewards balance.

In a particular example, a user decides to leave a reward for the next person who shows up at their favorite restaurant/bar (e.g., ‘pay it forward’). Within the app, the user can select a particular location (e.g., by name, geo-location, etc.) and a type of gift/reward (e.g., monetary amount, menu item, etc.) In doing so, the user can specify whether this reward is for anyone who can find the reward (e.g., based on an app or website) or if it is limited to a specific person or persons. Similarly, the user can specify whether or not the gifter is to be identified or anonymous. In this example, the gifter is leaving the gift/reward for a specific person or giftee.

Optionally, a notification and be generated and delivered (e.g., via SMS (short message service), via the app, via email, etc.) to the giftee (or group of giftees) to alert them of a gift/reward that awaits their retrieval. The notification can be sent immediately, scheduled or otherwise triggered based upon a geo-location (e.g., arrival at the venue).

The gift/reward processing can be based upon the type of gift/reward for example, deposited into the giftee's account, deducted from a restaurant tab, etc. Similarly, if the gift is a digital badge, it can be added to their profile that may trigger additional reward, incentives, status, etc. It is to be understood that the app host (e.g., credit card company) can make certain rewards location-dependent thereby enhancing the overall user experience(s).

While the description and examples set forth herein are tagged to location(s), it is to be understood that other aspects exist that can trigger gift rewards based upon additional or alternative conditions including but, not limited to time, date, weather, or other contextual factors. For example, a gift reward can be set to be valid and retrievable upon a particular date or even a notable date (e.g., holiday, birthday, etc.). In other examples, a gift reward can be valid if redeemed after a particular date but, before another identified date. Still further, reoccurring gift rewards can be set and triggered in accordance with the innovation. These and other iterations of gift and redemption criteria are to be included with the spirit and scope of the innovation and claims appended hereto.

Referring to the example of FIG. 1, a gifter 105 initiates a digital gift reward 110 to a giftee 115 at a location. The initiation location can be geo-marked as the location where the gifter 105 is presently located. In some embodiments, the gifter 105 can select a remote location to generate the digital gift reward 110. In yet other embodiments, the gifter 105 can choose from a set of pre-selected gifting locations to generate (e.g. “drop”) the gift reward 110 at a selected location. The digital gift reward 110 can be monetary, a badge, a discount, gift card, a specific item, a menu item, and/or the like.

The gifter 105 can generate the digital gift reward 110 using a gifter device 120. The gifter device 120 can be a mobile phone, smart phone, tablet, personal computing device, wearable device, internet of things (IoT) device, kiosk, and/or the like. The gifter device 120 can include processors, storage, networking hardware, screens, user interfaces, displays, keyboard, mice, GPS (global positioning system), location tracking hardware/software, and/or the like. The gifter device 120 can include applications or application instructions executed by processors. For example, the gifter device 120 can include a gifting interface application (‘app’) for initiating and interfacing for digital gift rewards 110.

The gifter device 120 can communicate and interface with a gift management system 125. In some embodiments, the gifter device 120 interfaces with the gift management system 125 via an application executed by processors of the gifter device 120. The gift management system 125 can reside on (or distributed among) a server, cloud, remote location, and/or the like. In some embodiments, the gift management system 125 is associated with a financial institution. The gift management system 125 manages transfer of gifts between parties (e.g. from gifters 105 to giftees 115).

The gifter device 120 can exchange data with the gift management system 125. For example, the gifter device 120 can send gift data to the gift management system 125 related specifically to the digital gift reward. The gift data can include gifter identity, gift type, denomination, currency, account, intended recipient, location, gift appearance, claiming instructions, and/or the like. In some embodiments, the gifter 105, via gifter device 120, can pre-select one or more criterion that can be converted into gift data and transmitted to the gift management system 125. In other embodiments, the gift device 120 can employ rules to parse and determine a subset of gift data to provide to the gift management system 125 in order to effect the gifting process. For example, the gift device 120 can determine location data for where the digital gift reward is to be dropped. Thereafter, other gift-related data can be conveyed to establish the placement of the gift.

The gift management system 125 can actively monitor a set of gift rewards in a database. For example, the gift management system 125 can monitor a set of gift rewards associated with the financial institution associated with a particular gift or scenario. The gift management system 125 can create a database entry or tag associated with each gift reward that is generated and gift data sent to the gift management system 125. In some embodiments, the digital gift reward 110 is a collectible badge. The badges can be collected and associated with the database entry of the giftee 115 in the gift management system 125. In some embodiments, the digital gift reward 110 is a collectible badge that is a blockchain based non-fungible token (NFT) or the like.

The giftee 115 can utilize a giftee device 130 to communicate with the gift management system 125. The giftee device 130 can be a mobile phone, smart phone, tablet, personal computing device, wearable device, internet of things (IoT) device, kiosk, and/or the like. The gifter device 120 can include processors, storage, networking hardware, screens, user interfaces, displays, keyboard, mice, GPS, location tracking hardware/software, and/or the like. The giftee device 130 can include applications or application instructions executed by processors. For example, the giftee device 130 can include a gifting interface application for generating digital gift rewards.

Upon receiving gift data from the gifter device 120, the gift management system 125 can generate and send a notification or alert regarding the existence of the digital gift reward 110 to the giftee device 130 or group of giftee devices (not shown). The gift management system 125 sends the notification via a communications network. The notification can be a text message, short message service (SMS), multimedia message service (MMS), push notification, application pop up, email, voice call, social media post, and/or the like. The notification can include part or all of the gift data. In some embodiments, the notification includes location data of the digital gift reward. In other aspects, the notification includes clues related to one or more of the type, location, gifter, initiation and/or expiration date(s), etc. related to the gift or reward. In one aspect, the location data can include GPS coordinates, address, Wi-Fi network, business name, venue nickname, monument, landmark, and/or the like.

In some embodiments, the notification can include a link that opens an application on the giftee device 130 or a portal website of the gift management system 125. The giftee 115 can open the notification on the giftee device 130. The giftee 115 can receive the gift data from the notification, application, portal, website, and/or the like. In some embodiments, the gift data and/or notification can include instructions for redeeming the digital gift reward 110.

In other embodiments, the gift management system 125 can actively and dynamically monitor the location of the giftee 115 via the giftee device 130. The giftee device 130 can provide location data to the gift management system 125 for monitoring and/or tracking. The giftee device 130 can provide location data intermittently, continuously (in real-time or near real-time), triggered upon opening the notification, and/or the like. The gift management system 125 can monitor the location of the giftee device 130 in relation to a proximity threshold 135. The proximity threshold 135 can be a distance from the digital gift reward 110. In some embodiments, the proximity threshold 135 is an even radius distance from the digital gift reward 110. In other embodiments, the proximity threshold 135 is a geofence, natural border, artificial boundaries (e.g. within walls of an establishment where the digital gift reward 110 is located), and/or the like. Additionally, the proximity threshold 135 can be a distance between the giftee 115 and the gifter 105 as established via their respective devices 130 and 120 respectively.

The gift management system 125 can detect that the giftee 115 and/or the giftee device 130 is within the proximity threshold 135. In some embodiments, a notification is generated and sent to the giftee device 130 upon detecting that the giftee 115 is within the proximity threshold 135 (e.g., near the digital gift reward 110).

The gift management system 125 can direct the giftee 115 to the gift upon detecting the giftee 115 and/or the giftee device 130 is within the proximity threshold 135. In some embodiments, the directions can be given to the giftee 115 upon receiving an intent that the giftee 115 wants to claim the digital gift reward 110. For example, the giftee 115 can select “provide claim instructions” on the notification or application of the giftee device 130.

The gift management system 125 can provide directions (e.g., GPS directions) to the giftee device 130 to the digital gift reward 110. The directions facilitate the giftee 115 in navigating to the location where the digital gift reward 110 has been dropped for claiming. The giftee device 130 can present the directions to the giftee 115. The giftee device 130 can provide GPS directions, map directions, text based directions, voice directions, traditional children's game of “hot/cold” directions, and/or the like. In some embodiments, the giftee device 130 can provide augmented reality directions to the digital gift reward 110.

In still other aspects, the giftee device 130 can generate an augmented reality view to present on a display of the giftee device 130. The augmented reality view updates in real time or near real time with movements of the giftee 115 and/or giftee device 130. The augmented reality view presents the directions as an overlay of a real world view concurrently presented on the giftee device 130. In some embodiments, the real world view is captured by an image capture device (e.g., camera) of the giftee device 130. For example, the augmented reality view can overlay direction arrows over a real world view to facilitate the giftee 115 navigating to the digital gift reward 110. In some embodiments, the augmented reality view can show a visual representation of the digital gift reward 110 at the location where the digital gift reward 110 was dropped. For example, the gifter 105 provided a digital gift reward 110 as a drink at a bar. The giftee device 130 can overlay a visual of a drink on top of the real world view of the bar at the location.

The gift management system 125 can determine the giftee 115 has satisfied at least one condition of transfer to claim or redeem to digital gift reward 110. The conditions of transfer can include a location, an action, a purchase request, placement of the mobile device (e.g., device 130) upon the augmented reality position and/or the like. In some embodiments, the gift management system 125 can provide instructions to the giftee 115 and/or the giftee device 130 as to how to claim or redeem the digital gift reward 110. When the giftee 115 has navigated to the digital gift reward 110, the digital gift reward 110 can be claimed. In some embodiments, the digital gift reward 110 is automatically claimed upon the giftee 115 navigating and/or being co-located with the digital gift reward 110. In other embodiments, the giftee 115 can select a redeem function on the giftee device 130 once co-located with the digital gift reward 110.

In other embodiments, the gift management system 125 can instruct the giftee 115 to perform an action to claim the digital gift reward 110. For example, the giftee 115 can be instructed to purchase a specific menu item or spend a minimum amount of money at an establishment to redeem the digital gift reward 110. In other embodiments, the gift management system 125 can request the giftee 115 perform an action and be recorded by the giftee device 130. The recording can be sent to the gift management system 125 or the gifter device 120 for validation and compliance. In another embodiment, the gift management system 125 can instruct the giftee 115 to appear to virtually pick up, grab, touch, consume and/or other action related to the digital gift reward 110 in the augmented reality view presented on the giftee device 130. For example, the giftee 115 can pretend to pick up the visual of the drink on the bar and consume the drink in the augmented reality view to claim the digital gift reward 110.

The gift management system 125 can manage transfer of the digital gift reward 110 from the gifter 105 to the giftee 115. The gift management system 125 can interface with or otherwise be associated with a financial institution. The gift management system 125 can transfer a monetary based digital gift reward 110 from a financial account of the gifter 105 to a financial account of the giftee 115 or to the vendor as appropriate. In some embodiments, the gift management system 125 transfers the digital gift reward 110 according to the gifter 105 settings provided or user-selected during generation of the digital gift reward. For example, the gifter 105 can generate the digital gift reward 110 to be transferred in dollars from the gifter 105 account to the giftee's 115 account. In other embodiments, the gift management system 125 can determine transfer preferences of the giftee 115. The giftee 115 can have a pre-selected preference of dollars for receiving digital gift rewards 110 that is stored by the gift management system 125.

In some embodiments, the gift management system 125 can learn preferences of the gifter 105 and/or the giftee 115. The gift management system 125 can employ a trained model using machine learning techniques to determine gift preferences of the gifter 105 and/or the giftee 115. The model can be trained with previous digital gift reward transactions, selections, contextual factors or the like. In other embodiments, the model can be trained using demographic data and matching the gifter 105 and/or the giftee 115 to other users of the gift management system 125 to determine a model of likely gift preferences for transfer between the gifter 105 and the giftee 115. The gift management system 125 determines a gift preference of the gifter 105 and/or giftee 115 by learning the preferences over time or using the demographic information of either as inputs into the trained model.

The gift management system 125 can detect a successful transfer of the digital gift reward 110 from the gifter 105 to the giftee 115. The gift management system 125 can determine whether the gifter 105 has earned a gifting reward. The gift management system 125 can also include reward rules to determine whether the gifter 105 has earned a gifting reward. For example, a reward rule can be an amount threshold, a counting threshold, a location threshold, a combination of thresholds, and/or the like. The gift management system 125 can deposit the reward into the gifter's 105 financial account in the financial institution. The reward can be monetary, a reward badge, a discount, gift card, and/or the like.

In some embodiments, the gifter 105 can initialize the digital gift reward 110 as a general gift that can be claimed by anyone. To claim a general digital gift reward 110, a user can be co-located with the digital gift reward 110 or be in near proximity having access to an application or portal to the gift management system 125 to claim the general digital gift reward 110. For example, the gifter 105 can drop a general digital gift reward 110 while waiting in line at a coffee shop. The next user that has access to the application and/or gift management system 125 can claim the digital gift reward 110. In some embodiments, the digital gift reward 110 can only be used at the particular location of the coffee shop or chain while in other aspects, the digital gift may be redeemed as any coffee shop location in the chain or franchises.

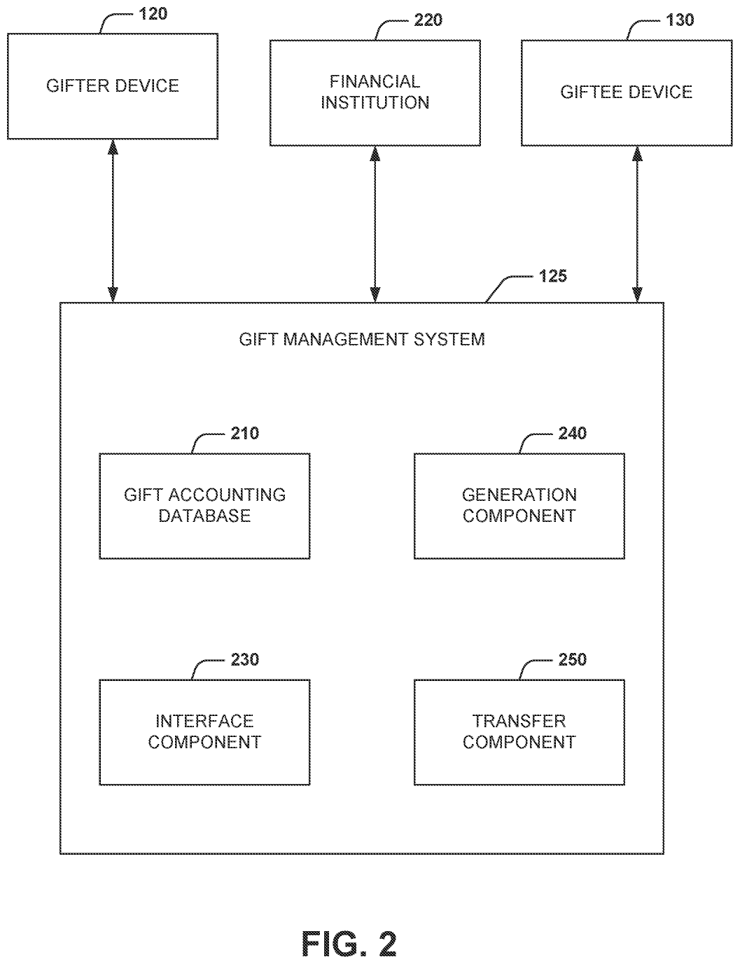

FIG. 2 illustrates a detailed component diagram of the gift management system 125 in accordance with aspects of the innovation. The gift management system 125 includes a gift accounting database 210. The gift accounting database 210 can track users of the gift management system 125. The gift accounting database 210 can track digital gift rewards 110 that are generated by the gift management system 125, gifters, gifter accounts, gifter devices 120, and/or the like. In some embodiments, the gift accounting database 210 can track digital gift rewards using a distributed ledger that maintains ownership data of gifts, blockchain based funds, NFTs, and/or the like. The gifter 105 can create an account in the gift accounting database 210 through which the gifter 105 can use to generate, manage, transfer, and/or the like of digital gift rewards 110. In some embodiments, the gifter 105 can automatically opt-in to a generated account by having a financial account, digital wallet, credit card, and/or the like with a financial institution 220.

The gift accounting database 210 can maintain a set of digital gift rewards. For example, the gift accounting database 210 can monitor a set of gift rewards associated with the financial institution 220. The gift accounting database 210 can create a database entry for each digital gift reward 110 that is generated and gift data sent to the gift management system 125.

The gift management system 125 includes an interface component 230. The interface component 230 can communicatively connect to the gifter device 120, the giftee device 130, the financial institution 220, and/or the like. The interface component 230 can send and receive data over a mobile network, internet, intranet, wireless network, GPS systems, and/or the like.

The interface component 230 can receive gift data from the gifter device 120. The gifter device 120 can send gift data to the gift management system 125 via the interface component 230. The gift data is related to the digital gift reward. The gift data can include gift type, denomination, currency, account, intended recipient, location, gift appearance, claiming instructions, and/or the like. In some embodiments, the gifter 105 can select one or more fields of gift data via the gifter device 120. In other embodiments, the interface component 230 can determine one or more fields of the gift data. For example, the interface component 230 can determine location data of the gifter device 120 for where the digital gift reward is dropped (or otherwise intended to be dropped).

The gift management system 125 includes a generation component 240. After a gifter 105 initiates a digital gift reward 110 to a giftee 115 at a location, the generation component 240 can generate the digital gift reward 110 and provide the digital gift reward 110 and gift data to the gift accounting database 210.

The interface component 230 can generate and send a notification regarding the existence of the digital gift reward 110 to the giftee device 130. The interface component 230 can transmit the notification over a communications network. The notification can be a text message, short message service (SMS), multimedia message service (MMS), push notification, application pop up, email, voice call, and/or the like. The notification can include part or all of the gift data. In some embodiments, the notification includes location data of the digital gift reward. The location data can be GPS coordinates, address, Wi-Fi network, business name, venue nickname, monument, landmark, and/or the like. In other aspects, clues as to the location of the gift reward can be provided.

In some embodiments, the notification can include a link that opens or launches an application on the giftee device 130 or a portal website of the interface component 230 and/or the gift management system 125. The giftee 115 can open the notification on the giftee device 130. The giftee 115 can receive the gift data from the notification, application, or portal website. In some embodiments, the gift data and/or notification can include instructions for redeeming the digital gift reward 110.

In some embodiments, the interface component 230 can monitor the location of the giftee 115 via the giftee device 130. The giftee device 130 can provide location data to the interface component 230 for monitoring and/or tracking. The giftee device 130 can provide location data intermittently, continuously (in real time or near real time), triggered upon opening the notification, and/or the like. The interface component 230 can monitor the location of the giftee device 130 in relation to a proximity threshold 135. The proximity threshold 135 can be a distance from the digital gift reward 110. In some embodiments, the proximity threshold 135 is an even radius distance from the digital gift reward 110. In other embodiments, the proximity threshold 135 is a geofence, natural border, artificial boundaries (e.g. within walls of an establishment where the digital gift reward 110 is located), and/or the like.

The interface component 230 can detect that the giftee 115 and/or the giftee device 130 is within the proximity threshold 135. In some embodiments, the interface component 230 generates and sends a notification to the giftee device 130 upon detecting that the giftee 115 is within the proximity threshold 135 (e.g., near the digital gift reward 110).

The interface component 230 can direct the giftee 115 to the gift upon detecting the giftee 115 and/or the giftee device 130 is within the proximity threshold 135. In some embodiments, the interface component 230 sends the directions to the giftee 115 upon receiving an intent that the giftee 115 wants to claim the digital gift reward 110. For example, the giftee 115 can select “provide claim instructions” on the notification or application of the giftee device 130 which is sent to the interface component 230.

The interface component 230 can provide directions to the giftee device 130 to the digital gift reward 110 based upon a present or current location. The directions facilitate the giftee 115 navigating to the location where the digital gift reward 110 has been dropped for claiming. The giftee device 130 can present the directions to the giftee 115. The interface component 230 can provide GPS directions, map directions, text based directions, voice directions, and/or the like. In some embodiments, the interface component 230 can provide augmented reality directions to the digital gift reward 110. The interface component 230 can generate an augmented reality view to present on a display of the giftee device 130. The augmented reality view updates in real time or near real time with movements of the giftee 115.

In aspects, the augmented reality view presents the directions as an overlay of a real world view concurrently presented on the giftee device 130. In some embodiments, the real world view is captured by a camera of the giftee device 130. For example, the augmented reality view can overlay direction arrows over a real world view to facilitate the giftee 115 navigating to the digital gift reward 110. In some embodiments, the augmented reality view can show a visual representation of the digital gift reward 110 at the location where the digital gift reward 110 was dropped. For example, the gifter 105 provided a digital gift reward 110 as a drink at a bar. The giftee device 130 can overlay a visual of a drink on top of the real world view of the bar.

The interface component 230 can determine the giftee 115 has satisfied at least one condition of transfer to claim or redeem to digital gift reward 110. The conditions of transfer can include a location, an action, a purchase request, and/or the like. In some embodiments, the interface component 230 can provide instructions to the giftee 115 and/or the giftee device 130 as to how to claim or redeem the digital gift reward 110. When the giftee 115 has navigated to the digital gift reward 110, the digital gift reward 110 can be claimed.

In some embodiments, the digital gift reward 110 is automatically claimed upon the giftee 115 navigating and/or being co-located (or within a defined proximity) with the digital gift reward 110. In other embodiments, the giftee 115 can select a redeem function on the giftee device 130 upon the interface component 230 detecting it is co-located with the digital gift reward 110.

In yet other embodiments, the interface component 230 can instruct the giftee 115 to perform an action to claim the digital gift reward 110. For example, the interface component 230 can instruct the giftee 115 to purchase a specific menu item or spend a minimum amount of money at an establishment to redeem the digital gift reward 110. In other embodiments, the interface component 230 can instruct the giftee 115 to perform an action and be recorded by the giftee device 130. In another embodiment, the interface component 230 can instruct the giftee 115 to appear to pick up, grab, touch, consume and/or other action on the digital gift reward 110 in the augmented reality view presented on the giftee device 130.

The gift management system 125 can also include a transfer component 250. The transfer component 250 can manage transfer of the digital gift reward 110 from the gifter 105 to the giftee 115. The transfer component 250 and/or the interface component 230 can interface with or otherwise be associated with the financial institution 220. The transfer component 250 can transfer a monetary based digital gift reward 110 from a financial account of the gifter 105 to a financial account of the giftee 115. In some embodiments, the transfer component 250 transfers the digital gift reward 110 according to the gifter 105 settings provided during generation of the digital gift reward 110. For example, the gifter 105 generated the digital gift reward 110 to be transferred in dollars from the gifter 105 account to the giftee's 115 account. In other embodiments, the transfer component 250 can determine transfer preferences of the giftee 115. The transfer component 250 can receive the giftee's 115 pre-selected preference of dollars for receiving digital gift rewards 110 that is stored by the gift accounting database 210.

In some embodiments, the transfer component 250 can learn preferences of the gifter 105 and/or the giftee 115. The transfer component 250 can train a model using machine learning techniques to determine gift preferences of the gifter 105 and/or the giftee 115. The transfer component 250 can train the model using previous digital gift reward transactions. In other embodiments, the transfer component 250 can train the model using demographic data and matching the gifter 105 and/or the giftee 115 to other user of the gift management system 125 to determine a model of likely gift preferences for transfer between the gifter 105 and the giftee 115. In some embodiments, the transfer component 250 determines a gift preference of the gifter 105 and/or giftee 115 by learning the preferences over time or using the demographic information of either as inputs into the trained model.

The transfer component 250 can detect a successful transfer of the digital gift reward 110 from the gifter 105 to the giftee 115. The transfer component 250 can determine whether the gifter 105 has earned a gifting reward. The transfer component 250 can include reward rules to determine whether the gifter 105 has earned a gifting reward. For example, a reward rule can be an amount threshold, a counting threshold, a location threshold, a combination of thresholds, and/or the like. The transfer component 250 can deposit the reward into the gifter's 105 financial account in the financial institution. The reward can be monetary, a reward badge, a discount, gift card, and/or the like. While aspects described herein describe a transfer of funds or financial responsibility, it is to be understood that other aspects can include a pre-paid gift reward that is auto-charged to the gifter. In these aspects, the giftee can redeem the gift as if it was merely left for retrieval without any subsequent payment, etc.

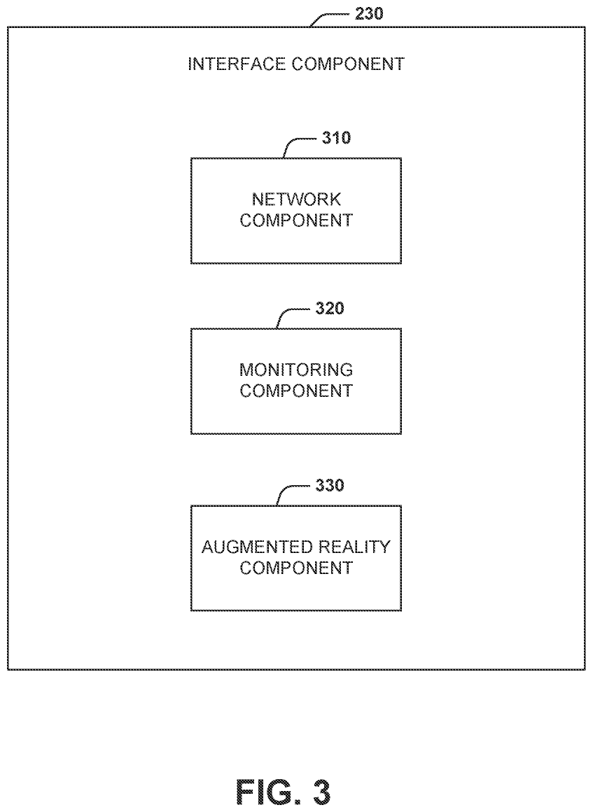

FIG. 3 illustrates a component diagram of an interface component 250. The interface component 230 includes a communications component 310. The communications component 310 can connect to the gifter device 120, the giftee device 130, the financial institution 220, and/or the like. The communications component 310 can send and receive data over a mobile network, internet, intranet, wireless network, GPS systems, and/or the like.

The communications component 310 can receive gift data from the gifter device 120. The gifter device 120 can send gift data to the communications component 310. The gift data is related to the digital gift reward 110. The gift data can include gift type, denomination, currency, account, intended recipient, location, gift appearance, claiming instructions, and/or the like. In some embodiments, the gifter 105 can select one or more fields of gift data on the gifter device 120. In other embodiments, the communications component 310 can determine one or more fields of the gift data. For example, the communications component 310 can determine location data of the gifter device 120 that identifies where the digital gift reward is/was dropped.

The communications component 310 can generate and send a notification regarding the existence of the digital gift reward 110 to the giftee device 130. The communications component 310 can transmit the notification over a communications network. The notification can be a text message, short message service (SMS), multimedia message service (MMS), push notification, application pop up, email, voice call, and/or the like. The notification can include part or all of the gift data. In some embodiments, the notification includes location data of the digital gift reward. The location data can be GPS coordinates, address, Wi-Fi network, business name, venue nickname, monument, landmark, and/or the like.

In some embodiments, the notification can include a link that opens an application on the giftee device 130 or a portal website of the communications component 310. The giftee 115 can open the notification on the giftee device 130. The giftee 115 can receive the gift data from the notification, application, or portal website. In some embodiments, the gift data and/or notification can include instructions for redeeming the digital gift reward 110.

The interface component 230 includes a monitoring component 320. In some embodiments, the monitoring component 320 can monitor the location of the giftee 115 via the giftee device 130. The giftee device 130 can provide location data to the monitoring component 320 for monitoring and/or tracking. The giftee device 130 can provide location data intermittently, continuously (in real time or near real time), triggered upon opening the notification, and/or the like. The monitoring component 320 can monitor the location of the giftee device 130 in relation to a proximity threshold 135. The proximity threshold 135 can be a distance from the digital gift reward 110. In some embodiments, the proximity threshold 135 is an even radius distance from the digital gift reward 110. In other embodiments, the proximity threshold 135 is a geofence, natural border, artificial boundaries (e.g. within walls of an establishment where the digital gift reward 110 is located), and/or the like.

The monitoring component 320 can detect that the giftee 115 and/or the giftee device 130 is within the proximity threshold 135. In some embodiments, the communications component 310 generates and sends a notification to the giftee device 130 upon the monitoring component 320 detecting that the giftee 115 is within the proximity threshold 135 (e.g., near the digital gift reward 110).

The communications component 310 can direct the giftee 115 to the gift upon detecting the giftee 115 and/or the giftee device 130 is within the proximity threshold 135. In some embodiments, the communications component 310 sends the directions to the giftee 115 upon receiving an intent that the giftee 115 wants to claim the digital gift reward 110. For example, the giftee 115 can select “provide claim instructions” on the notification or application of the giftee device 130 which is sent to the communications component 310.

The communications component 310 can provide directions to the giftee device 130 to the digital gift reward 110. The directions facilitate the giftee 115 navigating to the location where the digital gift reward 110 has been dropped for claiming. The giftee device 130 can present the directions to the giftee 115 on a display. The communications component 310 can provide GPS directions, map directions, text based directions, voice directions, and/or the like.

In some embodiments, the interface component 230 includes an augmented reality component 330. The augmented reality component 330 can provide augmented reality directions to the digital gift reward 110. The augmented reality component 330 can generate an augmented reality view to present on a display of the giftee device 130. The augmented reality view updates in real time or near real time with movements of the giftee 115. The augmented reality view presents the directions as an overlay of a real world view concurrently presented on the giftee device 130. In some embodiments, the real world view is captured by a camera of the giftee device 130. For example, the augmented reality view can overlay direction arrows over a real world view to facilitate the giftee 115 navigating to the digital gift reward 110. In some embodiments, the augmented reality view can show a visual representation of the digital gift reward 110 at the location where the digital gift reward 110 was dropped. For example, the gifter 105 provided a digital gift reward 110 as a drink at a bar (i.e. location). The augmented reality component 330 can overlay a visual of a drink on top of the real world view of the bar.

The monitoring component 320 can determine the giftee 115 has satisfied at least one condition of transfer to claim or redeem to digital gift reward 110. The conditions of transfer can include a location, an action, a purchase request, and/or the like. In some embodiments, the communications component 310 can provide instructions to the giftee 115 and/or the giftee device 130 as to how to claim or redeem the digital gift reward 110. When the giftee 115 has navigated to the digital gift reward 110, the digital gift reward 110 can be claimed. In some embodiments, the digital gift reward 110 is automatically claimed upon the giftee 115 navigating and/or being co-located with the digital gift reward 110. In other embodiments, the giftee 115 can select a redeem function on the giftee device 130 upon the monitoring component 320 detecting it is co-located with the digital gift reward 110. In other embodiments, the communications component 310 can instruct the giftee 115 to perform an action to claim the digital gift reward 110. For example, the communications component 310 can instruct the giftee 115 to purchase a specific menu item or spend a minimum amount of money at an establishment to redeem the digital gift reward 110. In other embodiments, the communications component 310 can instruct the giftee 115 to perform an action and be recorded by the giftee device 130. In another embodiment, the communications component 310 can instruct the giftee 115 to appear to pick up, grab, touch, consume and/or other action on the digital gift reward 110 in the augmented reality view presented on the giftee device 130.

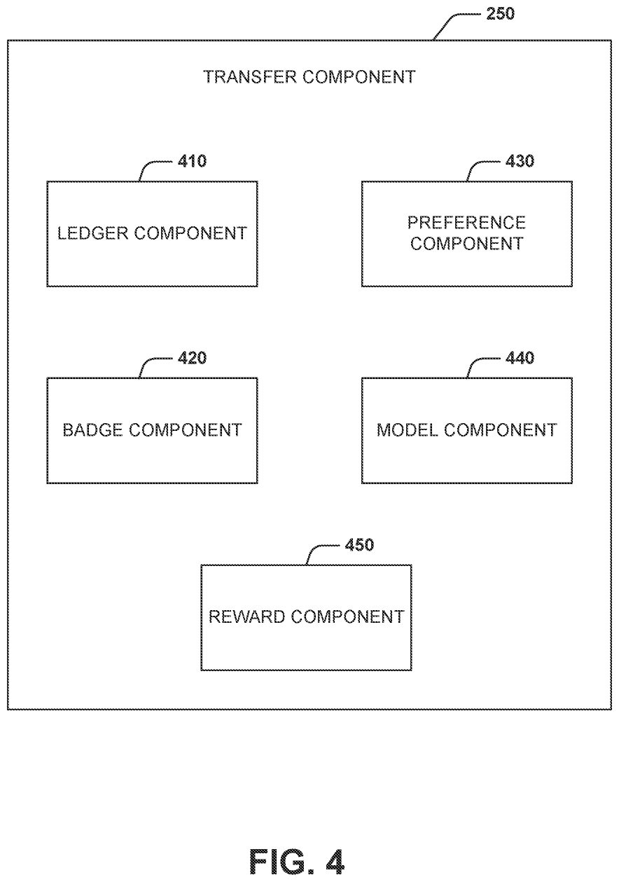

FIG. 4 illustrates a component diagram of a transfer component 250 in accordance with aspects. The transfer component 250 can manage transfer of the digital gift reward 110 from the gifter 105 to the giftee 115. The transfer component 250 and/or the interface component 230 can interface with or otherwise be associated with the financial institution 220. The transfer component 250 includes a ledger component 410. The ledger component 410 can transfer a monetary based or a blockchain based digital gift reward 110 from a financial account of the gifter 105 to a financial account of the giftee 115.

The transfer component 250 includes a badge component 420. The badge component 420 can transfer or provide badges between the gifter 105 and the giftee 115. The badge component 420 can organize badges that are collected and associated with the database entry of the giftee 115 in the gift accounting database 210. In some embodiments, the digital gift reward 110 is a collectible badge that is a blockchain based non-fungible token (NFT).

The transfer component 250 includes a preference component 430. In some embodiments, the ledger component 410 transfers the digital gift reward 110 according to the preferences in the preference component 430 that were provided during generation of the digital gift reward 110. For example, the gifter 105 generated the digital gift reward 110 to be transferred in dollars from the gifter 105 account to the giftee's 115 account. In other embodiments, the preference component 430 can determine transfer preferences of the giftee 115. The preference component 430 can receive the giftee's 115 pre-selected preference of dollars for receiving digital gift rewards 110 that is stored by the gift accounting database 210.

In some embodiments, the transfer component 250 include a model component 440. The preference component 430 can learn preferences of the gifter 105 and/or the giftee 115 using a model developed by the model component 440. The model component 440 can train a model using machine learning techniques to determine gift preferences of the gifter 105 and/or the giftee 115. The model component 440 can train the model using previous digital gift reward transactions. In other embodiments, model component 440 can train the model using demographic data and matching the gifter 105 and/or the giftee 115 to other user of the gift management system 125 to determine a model of likely gift preferences for transfer between the gifter 105 and the giftee 115. In some embodiments, the preference component 430 determines a gift preference of the gifter 105 and/or giftee 115 by learning the preferences over time or using the demographic information of either as inputs into the trained model.

The transfer component 250 includes a reward component 450. The reward component 450 can detect a successful transfer of the digital gift reward 110 from the gifter 105 to the giftee 115. The reward component 450 can determine whether the gifter 105 has earned a gifting reward. The reward component 450 can include reward rules to determine whether the gifter 105 has earned a gifting reward. For example, a reward rule can be an amount threshold, a counting threshold, a location threshold, a combination of thresholds, and/or the like. The reward component 450 can deposit the reward into the gifter's 105 financial account in the financial institution. The reward can be monetary, a reward badge, a discount, gift card, and/or the like.

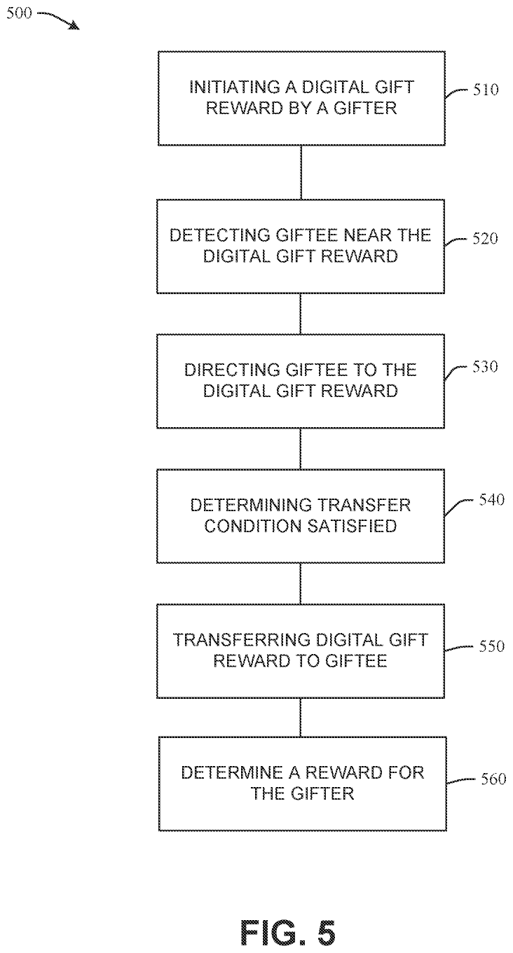

With reference to FIG. 5, example method 500 is depicted for authenticating a user to verify identity. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 are described in conjunction with a specific example is for explanation purposes.

FIG. 5 illustrates a method 500 for digital gift reward management. At 510, a digital gift reward 110 is initialized by a gifter 105 via a gifter device 120. In aspects, the digital gift reward 110 is generated by a gift management system 125. The digital gift reward 110 includes gift data such as location, amount, type, claiming instructions, giftee 115, and/or the like. At 520, the giftee 115 is detected near (or otherwise approaching) the digital gift reward. The gift management system 125 can detect that the giftee 115 is within a proximity threshold 135 of the digital gift reward 110. At 530, the giftee 115 is directed to the digital gift reward 110. The gift management system 125 can generate and send a notification to the giftee 115 on a giftee device 130 notifying that a digital gift reward 110 is near their location. The gift management system 125 can send directions or generate and provide an augmented reality view to the giftee device 130.

At 540, a transfer condition is determined to be satisfied. The gift management system 125 monitors for conditions of transfer. The conditions of transfer can be co-location with the digital gift reward 110, an action, and/or the like. At 550, the digital gift reward 110 is transferred to the giftee 115. The gift management system 125 can transfer the digital gift reward 110 to the giftee upon the conditions of transfer being satisfied. The gift management system 125 can transfer the digital gift reward 110 from a gifter account to a giftee account. At 560, a reward for gifter 105 can be determined. The gift management system 125 can determine if the gifter has satisfied a reward rule or has otherwise earned a gifting reward. The gift management system 125 can transfer the gifting reward into the gifter account at a financial institution.

The innovation disclosed and claimed herein, in one aspect thereof, comprises systems and methods of digital gift rewards. A method can include initiating a digital gift reward from a gifter at a location. The method includes detecting a device within a proximity of the location wherein the user device is associated with a giftee and determining the giftee has satisfied at least one condition of transfer. The method further includes transferring the gift reward to the giftee according to the gift reward preference.

A system of the innovation can include a generation component that generates a digital gift reward from a gifter at a location. An interface component detects a device within a proximity of the location wherein the user device is associated with a giftee and determines the giftee has satisfied at least one condition of transfer. A transfer component transfers the gift reward to the giftee according to the gift reward preference.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

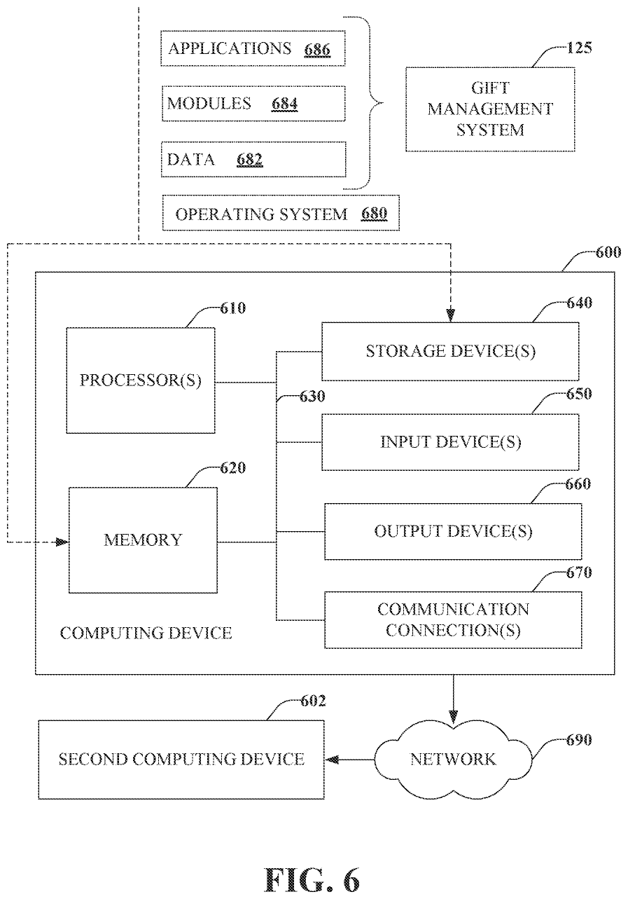

To provide a context for the disclosed subject matter, FIG. 6 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 610 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that accessible to the computing device 600 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 620 and storage device(s) 640 are examples of computer-readable storage media. Depending on the configuration and type of computing device, the memory 620 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 600, such as during start-up, can be stored in nonvolatile memory, while volatile memory can act as external cache memory to facilitate processing by the processor(s) 610, among other things.

The storage device(s) 640 include removable/non-removable, volatile/non-volatile storage media for storage of vast amounts of data relative to the memory 620. For example, storage device(s) 640 include, but are not limited to, one or more devices such as a magnetic or optical disk drive, floppy disk drive, flash memory, solid-state drive, or memory stick.

Memory 820 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the gift management component 125 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the gift management component 125 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth . . . ), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of gift management component 125, and the second computing device 602 can be a user device that communications and interacts with the computing device 600.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
initiating a digital gift reward from a gifter at a location;
detecting a giftee device within a proximity threshold of the location, wherein the giftee device is associated with a giftee identified to receive the digital gift reward;
determining the giftee has satisfied at least one condition of transfer; and
transferring the digital gift reward to the giftee based on the determination.

2. The method of claim 1, further comprising:
generating and delivering a notification to the giftee device associated with the giftee regarding the location of the digital gift reward.

3. The method of claim 1, further comprising:
directing the giftee to the digital gift reward via an interface on the giftee device upon detecting the giftee intends to accept the digital gift reward.

4. The method of claim 3, further comprising employing an augmented reality view via the giftee device to direct the giftee to the digital gift reward, wherein the augmented reality view updates in near real time with movements of the giftee, and wherein the augmented reality view presents the directions as an overlay of a real world view concurrently presented on the giftee device.

5. The method of claim 1, further comprising:
training a model with one or more machine learning techniques to determine a reward preference of the giftee, wherein the model is trained with previous digital gift reward claims of the giftee or previous digital gift reward transfers of the gifter.

6. The method of claim 1, further comprising
wherein the at least one condition includes at least one of a location, an action, or a purchase request.

7. The method of claim 1, further comprising:
detecting, via a network, a successful digital gift reward transfer to the giftee;
determining the gifter has earned a gifting reward based on the digital gift reward; and
providing the gifting reward to the gifter via the network.

8. The method of claim 1, further comprising:
wherein the digital gift reward is a monetary transfer from a gifter account to a giftee account.

9. The method of claim 1, further comprising:
wherein the digital gift reward is a collectible badge that is a blockchain based non-fungible token (NFT).

10. A system, comprising:
a processor coupled to a memory storing instructions that are executed by the processor, the instructions comprising:
initiating a digital gift reward from a gifter at a location;
detecting a giftee device within a proximity threshold of the location, wherein the giftee device is associated with a giftee tagged to receive the digital gift reward;
determining, via the processor, that the giftee has satisfied at least one condition of transfer; and
transferring the digital gift reward to the giftee based on the determination.

11. The system of claim 10, further comprising:
generating and sending a notification to the giftee device associated with the giftee regarding the location of the digital gift reward.

12. The system of claim 10, further comprising:
directing the giftee to the digital gift reward via the giftee device upon detecting that the giftee intends to accept the digital gift reward.

13. The system of claim 12, further comprising
wherein the directing employs an augmented reality view via the giftee device that updates in near real time with movements of the giftee, and wherein the augmented reality view presents the directions as an overlay of a real world view concurrently presented on the giftee device.

14. The system of claim 10, further comprising:
training a model with one or more machine learning techniques to determine a reward preference of the giftee, wherein the model is trained with previous digital gift reward claims of the giftee or previous digital gift reward transfers of the gifter.

15. The system of claim 10, further comprising
wherein the at least one condition includes at least one of a location, an action, or a purchase request.

16. The system of claim 10, further comprising:
detecting a successful digital gift reward transfer to the giftee by a financial institution;
determining the gifter has earned a gifting reward based on the digital gift reward; and
providing the gifting reward to the gifter from the financial institution.

17. The system of claim 10, further comprising:
wherein the digital gift reward is a monetary transfer from a gifter account to a giftee account.

18. The system of claim 10, further comprising:
a collectible badge that is a blockchain based non-fungible token (NFT), wherein the collectible badge is the digital gift reward.

19. A computer readable medium having instructions to control one or more processors configured to:
initiate a digital gift reward from a gifter, wherein the gift is tagged associated with a location;
detect a giftee device within a proximity threshold of the location, wherein the giftee device is associated with a giftee identified to receive the digital gift reward;
determine, via data from the giftee device, that the giftee has satisfied at least one condition of transfer; and
transfer the digital gift reward to the giftee based on the determination.

20. The computer readable medium of claim 19, wherein the one or more processors are further configured to:
direct the giftee to the digital gift reward on the giftee device upon detecting the giftee intends to accept the digital gift reward, wherein directions to the digital gift reward are rendered via an augmented reality view via the giftee device, wherein the augmented reality view updates in near real time based upon movements of the giftee, and wherein the augmented reality view presents the directions as an overlay of a real world view concurrently rendered via the giftee device.
